(19) United States
(12) Patent Application Publication
(10) Pub. No.: US 2025/0100345 A1
(43) Pub. Date: Mar. 27, 2025

(54) VEHICLE CABIN PRECONDITIONING

(71) Applicant: Siemens Aktiengesellschaft, München (DE)

(72) Inventors: Timothy Hughes, Christchurch (GB); Sricharan Pamudurthi, Hosur, Tamil Nadu (IN); Smaran Subbaiah Bommanda Ganapathi, Nürnberg (DE); Chitira Vazhappully, Bangalore, Karnataka (IN)

(21) Appl. No.: 18/727,173

(22) PCT Filed: Jan. 11, 2022
(86) PCT No.: PCT/EP2022/050420

§ 371 Date: Jul. 8, 2024

(51) Int. Cl. B60H 1/00; B60L 53/66

(52) U.S. Cl. CPC B60H 1/00735; B60L 53/66; B60L 2240/34; B60L 2260/56; B60L 2260/58

(57) ABSTRACT

A computer implemented method, a cabin preconditioning system, a computer program product, and a charger for preconditioning a cabin of vehicle(s), are provided, and include detecting a connection of the vehicle(s) to the charger, obtaining vehicle data having preconditioning requirements of the vehicles and battery data associated with an energy storage device of the vehicles, and departure schedule associated with each of the vehicle(s) connected to the charger, generating a cabin preconditioning profile for the charger based on the vehicle data, the departure schedule, and a number of the vehicles connected to the charger for preconditioning the cabin of the vehicle(s) connected to the charger.

### CROSS-REFERENCE TO RELATED APPLICATIONS

This application is a national stage of PCT Application No. PCT/EP2022/050420, having a filing date of Jan. 11, 2022, the entire contents of which are hereby incorporated by reference.

### FIELD OF TECHNOLOGY

The following relates to a system and a method for preconditioning a cabin of a vehicle. More particularly, the following relates to a system and a method for controlling an amount of charge delivered by a charger to the vehicle, the cabin of which is to be preconditioned.

### BACKGROUND

Preconditioning of vehicles having at least a partial electric drive, hereinafter referred to as electric vehicles (EVs), is a process of pre-heating and/or pre-cooling an interior of a vehicle before the vehicle begins its journey, that is, pre-heating and/or pre-cooling a cabin of the vehicle which typically accommodates passengers therewithin. Preconditioning ensures that the temperature of the cabin is either brought up or brought down to a temperature that is desirable for the vehicle passengers on an average, during the journey.

An e-Depot is a depot that typically manages a fleet of EVs including e-Buses, e-Trucks, e-Cars, etc. To ensure smooth operations of the e-Depot, it is essential that the EVs are preconditioned before their scheduled departure from the e-Depot. Typically, a depot operator would prefer to use electricity from the grid to do preconditioning, instead of energy stored in the battery of the EV to save State of Charge (SoC) of vehicle battery.

However, the EVs are required to be preconditioned according to their departure schedules. If this is not achieved, the EV is declared unfit for its assigned trip. Typically, this EV needs to be replaced by another EV which is fit for service and undertaking the trip.

Moreover, an e-Depot may have various chargers deployed therein including, for example, sequential chargers and/or parallel chargers. The sequential chargers are capable of charging one EV attached to its connectors at a time. When there are multiple EVs connected to different connectors of the sequential charger, one or more of these EVs may not be preconditioned within time of their scheduled departure or will have lesser then expected SoC due to the energy from the battery being utilized for preconditioning.

Furthermore, an e-Depot may have resource limitations such as power constraints, schedule constraints, infrastructure constraints, etc., due to which preconditioning of all scheduled EVs may not be possible.

Conventional methods used for cabin preconditioning of EVs include automatic preconditioning and manual preconditioning. In automatic preconditioning, the EVs are automatically preconditioned after the charging of the vehicle battery is completed. However, this is not an optimized solution as energy is consumed irrespective of when the EV is scheduled to depart and leads to unnecessary energy costs. In manual preconditioning the EVs are preconditioned upon triggering of a button or upon getting a scheduled departure time from a user input or a depot scheduling system. However, such manually triggered charging is often uncontrolled, is subject to human errors and can cause unwarranted power peaks and penalties.

Some other conventional methods used for cabin preconditioning of EVs are generally clubbed with the control of primary charging of the EVs, that is, of the vehicle battery and therefore, are reliant on multitude of parameters such as current temperature of the cabin and of the vehicle battery, current state of charge of the vehicle battery, a desired temperature of the cabin, data associated with the next charging station, charging station, etc., ambient temperature, detecting passenger availability during the charging, weather forecast at the destination at the time of arrival of the EV and/or during the course of the trip, etc. Such conventional methods unnecessarily complicate the controlled charging and utilize more resources, time, effort and costs.

### SUMMARY

An aspect relates to a cabin preconditioning system and a method for preconditioning a cabin of vehicle(s), that is EVs, that are connectable to a charger, which is automated yet ensures minimal wastage of energy and minimal loss of state of charge (SoC) due to preconditioning of the vehicles and is based on optimal number parameters.

The present disclosure achieves the aforementioned aspect by providing a cabin preconditioning system and a computer implemented method for preconditioning a cabin of vehicle(s) that can be connected to a charger. As used herein, “cabin” refers to an interior of a vehicle which accommodates therewithin one or more passengers for whom the conditions associated with the environment defined by the cabin are controlled during preconditioning. The conditions include, for example, temperature, pressure, humidity, air quality, etc., that are generally desirable to the passengers that may be accommodated within the cabin. These conditions are predefined, for example, by a fleet management system responsible for managing the vehicles.

Also used herein, “preconditioning” refers to dispensing power from the charger(s), to which a vehicle is connected, for controlling the aforementioned conditions of the cabin of the vehicle prior to the scheduled departure of the vehicle. It may be appreciated that the term “vehicle” used herein refers to any automobile that has at least a partial electric drive and therefore, requires to be charged. The term vehicle and electric vehicle (EV) are used interchangeably throughout the present disclosure.

The computer implemented method disclosed herein detects a connection of the vehicle(s) to the charger, for example, via a connector of the charger. The charger is a sequential charger that is capable of charging one vehicle at a time. It would be appreciated by a person skilled in the conventional art, that the term “charging a vehicle” used throughout the present disclosure refers to providing charge to an energy storage device such as a battery that is installed within the vehicle.

The computer implemented method obtains vehicle data and departure schedule associated with each of the vehicle(s) connected to the charger.

The vehicle data includes preconditioning requirements of the vehicle(s) and battery data associated with the energy storage device of the vehicle(s). As used herein, “preconditioning requirements” refer to a preconditioning energy and a preconditioning duration associated with the vehicle. For example, an e-Bus may require 10 kWh of preconditioning energy for 2 hours of cabin preconditioning. It may be appreciated by a person skilled in the conventional art, that these preconditioning requirements may be obtained, that is, derived from one or more parameters pertaining to the cabin conditions. For example, the vehicle data may include a desired cabin temperature, a desired cabin pressure, etc., from which the preconditioning energy and/or the preconditioning duration may be derived.

The battery data includes a state of charge (SoC) of the energy storage device at the time of connection of the vehicle(s) to the charger and a rate of charging of the energy storage device when connected to the charger. The battery data may also include a desired SoC at the end of the charging, that is, preconditioning. It may be appreciated by a person skilled in the conventional art, that the battery data may be obtained, that is, derived from one or more parameters pertaining to the vehicles. For example, the battery data may be derived from a route that the vehicle(s) are expected to take and/or a departure schedule of the vehicle(s), and/or historical performance of the battery.

The battery data may also include a capacity of the energy storage device to store charge, a maximum charging power that the energy storage device can handle, and balancing parameters comprising, for example, balancing power, balancing duration, balancing state of charge, etc.

The vehicle data may also include data associated with identification of the vehicle such as a vehicle identification number (VIN), a vehicle communication controller identification number (EVVCCID), etc. According to one embodiment, the computer implemented method obtains the vehicle data from a charging management system associated with a charging station in which the charger is installed. The vehicle(s) are onboarded onto such charging management system. According to another embodiment, the computer implemented method obtains the vehicle data from the vehicle once connected to the charger.

The departure schedule includes an expected time of departure of the vehicle(s), for example, from a charging station where the charger is installed. Such a schedule is typically managed by a vendor, for example, a fleet manager managing a fleet of the vehicle(s). According to one embodiment, the computer implemented method obtains the departure schedule from a fleet management system. According to another embodiment, the computer implemented method obtains the departure schedule as a user input.

According to an embodiment, the computer implemented method obtains, from the charging management system, data associated with the charger, comprising, for example, a type of the charger, number of connectors of the charger, maximum charging power deliverable by the charger, etc.

According to another embodiment, the computer implemented method obtains, from an energy management system, data associated with an external power supply using which the charger charges the vehicle(s), comprising, for example, availability of power, power pricing at various times of a day, etc.

The computer implemented method generates a cabin preconditioning profile for the charger based on the vehicle data, the departure schedule, and a number of vehicles connected to the charger. The charger based on its number of connectors may allow connection of more than one vehicle for charging. As used herein, “cabin preconditioning profile” refers to a set of instructions to be used by the charger while charging the vehicle(s). The cabin preconditioning profile comprises a preconditioning start time and a charger power output for each of the vehicle(s) connected to the charger. The charger begins delivery of power to the vehicle at the preconditioning start time equivalent to the charger power output. For example, at 4:30 AM with 5 kW. The cabin preconditioning profile is further provided to each connector of the charger. For example, if a charger has 2 connectors and 2 vehicles are connected thereto, then there are 2 cabin preconditioning profiles generated for each of the connectors to provide power to the respective vehicles at the preconditioning start time equivalent to the charger power output.

The computer implemented method for generating the cabin preconditioning profile, determines a number of vehicles connected to the charger. The computer implemented method further determines, based on the departure schedule and the preconditioning requirements, the preconditioning start time for the vehicle(s) connected to the charger. The preconditioning start time may be represented as below:

$$PST = \vert PD - DT \vert$$

Where PST represents the preconditioning start time, PD represents the preconditioning duration and DT represents the expected departure time of the vehicle.

Thus, for an e-Bus scheduled to depart at 6:00 AM from the charging station and requiring to be preconditioned for 2 hours, the preconditioning start time is 4:00 AM.

The computer implemented method further determines, based on the preconditioning start time and the preconditioning requirements, a preconditioning overlap between two or more vehicles when the number of vehicles connected to the charger is greater than one. For example, when there are two e-Buses Bus A and Bus B connected to the charger and scheduled to depart from the charging station at 6:00 AM and 6:30 AM respectively and both requiring to be preconditioned for 2 hours, then there exists a preconditioning overlap. This is because the preconditioning would last for the Bus A and the Bus B between 4:00 AM to 6:00 AM and 4:30 AM to 6:30 AM respectively. Thus, there would be a preconditioning overlap from 4:30 AM to 6:00 AM, that is, until Bus A is fully preconditioned and ready to depart from the charging station.

The computer implemented method further determines the charger power output of the charger using the preconditioning requirements and/or the battery data, based on the number of vehicles and the preconditioning overlap. According to an embodiment, the computer implemented method determines a charger current output and the charger power output is derived based on the charger current output and a voltage detected at the battery of the vehicle.

According to one embodiment, the computer implemented method generates the charger power output based on the preconditioning requirements when the number of vehicles connected to the charger is equal to one.

According to another embodiment, the computer implemented method generates the charger power output based on the preconditioning requirements when the number of vehicles connected to the charger is greater than one with absence of the preconditioning overlap.

The charger power output determined based on the preconditioning requirements, according to the above embodiments, may be represented as below:

$${P}_{output} = PE / PD$$

Where Pₒᵤₜₚᵤₜ is the charger power output, PE is the preconditioning energy requirement of the vehicle and PD is the preconditioning duration requirement of the vehicle.

According to yet another embodiment, the computer implemented method generates the charger power output based on the preconditioning requirements and the battery data when the number of vehicles connected to the charger is greater than one with presence of the preconditioning overlap.

The charger power output determined based on the preconditioning requirements and the battery data, according to the above embodiment, may be represented as below:

$${P}_{output} = [ \frac{PE}{PD} ] + [ {SoC}_{Loss} * RoC ]$$

Where Pₒᵤₜₚᵤₜ is the charger power output, PE is the preconditioning energy requirement of the vehicle, PD is the preconditioning duration requirement of the vehicle, SoC_{Loss} is the loss of the state of charge (SoC) of the battery and RoC is the rate of charging of the battery. According to this embodiment, the loss of state of charge in the battery, that is, the energy storage device, results from a time-shared charging between the two or more vehicles during the preconditioning overlap. During the preconditioning overlap, the charger and the battery alternately provide power for the cabin preconditioning thus, resulting in a loss of state of charge of the battery. The cabin preconditioning profile, that is generated for the aforementioned time-shared charging, comprises multiple time intervals corresponding to the preconditioning overlap such that the charger power output is to be provided to the two or more vehicles by the energy storage device or the charger in each of the time intervals, for example, in a round robin manner.

According to one embodiment, the duration of each time interval and the number of the time intervals are predefined based on the historical preconditioning requirements and the cabin preconditioning profiles of the vehicles.

According to another embodiment, the computer implemented method determines the duration of each time interval and the number of the time intervals based on the state of charge of the battery prior to the time interval, the duration for which the preconditioning overlap is foreseen, and an estimated loss of the state of charge during the time-shared charging. The computer implemented method estimates the loss of state of charge based on historical data associated with the vehicle(s) and/or a rate of discharge of the battery. The computer implemented method validates the estimated loss of state of charge in the subsequent time intervals and if required updates the estimated value used in the first time-interval for determining the charger power output.

The computer implemented method transfers the cabin preconditioning profile to the charger for preconditioning the cabin of the vehicle(s) connected to the charger. The computer implemented method stores the cabin preconditioning profile in a preconditioning database of a cabin preconditioning system, any memory units available in the charger, or a database of the charging management system. The cabin preconditioning profiles thus stored and analysed facilitate corrective actions to be taken like manual or automatic rescheduling of vehicles or planning activities like upgrading the infrastructure of the charging station to support the required fleet schedules, etc.

Also disclosed herein, is the cabin preconditioning system for preconditioning a cabin of one or more vehicles that can be connected to a charger. The cabin preconditioning system comprises a non-transitory computer readable storage medium storing computer program instructions defined by modules of the cabin preconditioning system, at least one processor communicatively coupled to the non-transitory computer readable storage medium, and executing the computer program instructions, and the modules of the cabin preconditioning system.

The cabin preconditioning system disclosed herein is in an operable communication with a charging station, for example, over a communication network. The charging station comprises one or more chargers each of which is connectable, for example, in a wired or wireless manner, to multiple vehicles, via the connectors of the charger. The chargers are sequential chargers. The vehicles have at least a partial electric drive and therefore require to be charged via electric chargers.

According to one embodiment, the cabin preconditioning system is configurable as a web-based platform, for example, a website hosted on a server or a network of servers, for preconditioning a cabin of the vehicles that are connected to the chargers.

According to another embodiment, the cabin preconditioning system is implemented in the cloud computing environment as a cloud computing-based platform implemented as a service for preconditioning a cabin of the vehicles that are connected to the chargers.

According to yet another embodiment, the cabin preconditioning system is configured as an edge-based offering that is installable at the charging station for preconditioning a cabin of the vehicles that are connected to the chargers.

The cabin preconditioning system is capable of establishing communication, for example, via the communication network with the charger(s) and the vehicles once connected to the charger(s), for example, for obtaining the data associated with the chargers and the vehicle data.

The cabin preconditioning system is in communication with a fleet management system, for example, via the communication network, for example, for obtaining the departure schedule and/or the vehicle data.

The cabin preconditioning system is also in communication with an energy management system, for example, via the communication network, for example, for obtaining the data associated with the external power supply.

The modules of the cabin preconditioning system comprise a data reception module and a data processing module communicatively coupled to one another. It would be appreciated by a person skilled in the conventional art that these modules may be combined into a single module.

The data reception module obtains the vehicle data, the departure schedule, the data associated with the chargers, and/or the data associated with the external power supply, in communication with the charger(s), the vehicle(s) and/or the fleet management system, and the energy management system respectively.

The data processing module detects a connection of the vehicle(s) to the charger, generates a cabin preconditioning profile for the charger based on the vehicle data, the departure schedule, and a number of vehicles connected to the charger, and transfers the cabin preconditioning profile to the charger for preconditioning the cabin of the vehicle(s) connected to the charger.

The data processing module determines a number of vehicles connected to the charger, determines, based on the departure schedule and the preconditioning requirements, a preconditioning start time for the vehicle(s) connected to the charger, determines, based on the preconditioning start time and the preconditioning requirements, a preconditioning overlap between two or more vehicles when the number of vehicles connected to the charger is greater than one, and determines a charger power output of the charger using the preconditioning requirements and/or the battery data, based on the number of vehicles and the preconditioning overlap.

The data processing module generates the charger power output based on the preconditioning requirements when the number of vehicles connected to the charger is equal to one or when the number of vehicles connected to the charger is greater than one with absence of the preconditioning overlap.

The data processing module generates the charger power output based on the preconditioning requirements and the battery data when the number of vehicles connected to the charger is greater than one with presence of the preconditioning overlap.

Also disclosed herein is a computer program product (non-transitory computer readable storage medium having instructions, which when executed by a processor, perform actions) for preconditioning a cabin of one or more vehicles. The computer program product comprises a non-transitory computer readable storage medium that stores computer program codes comprising instructions executable by at least one processor for preconditioning a cabin of vehicle(s), as disclosed in aforementioned description.

Also disclosed herein is a charger for preconditioning a cabin of vehicle(s) that can be connected to the charger. The charger comprises connector(s) via which the vehicle(s) connect to the charger. The charger comprises a control unit that detects a connection of the vehicle(s) to the connectors, obtains vehicle data and departure schedule associated with each of the vehicle(s), and generates a cabin preconditioning profile for the charger based on the vehicle data, the departure schedule, and a number of the vehicle(s) connected to the charger, for preconditioning the cabin of the vehicle(s). The cabin preconditioning profile is stored in the charger, for example, in a memory unit of the charger.

The control unit of the charger in order to generate the cabin preconditioning profile, determines a number of the vehicles connected to the charger, for example, via the connectors, determines, based on the departure schedule and the preconditioning requirements, a preconditioning start time for the vehicles connected to the charger, determines, based on the preconditioning start time and the preconditioning requirements, a preconditioning overlap between two or more of the vehicles when the number of the vehicles connected to the charger is greater than one, determines a charger power output of the charger in accordance with the preconditioning requirements, the battery data, the number of the vehicles, and the preconditioning overlap, and generates the cabin preconditioning profile using the preconditioning start time and the charger power output for each of the vehicle(s) connected to the charger.

The control unit of the charger determines the charger power output based on the preconditioning requirements when the number of the vehicles connected to the charger is equal to one.

The control unit of the charger determines the charger power output based on the preconditioning requirements when the number of the vehicles connected to the charger is greater than one with absence of the preconditioning overlap.

The control unit of the charger determines the charger power output based on the preconditioning requirements and the battery data when the number of the vehicles connected to the charger is greater than one with presence of the preconditioning overlap.

The charger is a sequential charger that provides the charger power output to no more than one of the vehicles(s) at any given time.

The computer implemented method, the cabin preconditioning system, the computer program product and the charger disclosed herein enable optimization of power consumption and delivery via the charger such that required amount of power for preconditioning is spent at the required time while minimizing wastage of energy. Moreover, the computer implemented method, the cabin preconditioning system, the computer program product, and the charger disclosed herein ensure that the cabin preconditioning of the vehicle(s) is triggered automatically based on a priority of departure time of the vehicle(s). Furthermore, the computer implemented method, the cabin preconditioning system, the computer program product, and the charger disclosed herein minimize the loss of SoC due to cabin preconditioning for vehicles charged with sequential chargers.

The above mentioned and other features of embodiments of the invention will now be addressed with reference to the accompanying drawings of embodiments of the present invention. The illustrated embodiments are intended to illustrate, but not limit the invention.

### BRIEF DESCRIPTION

Some of the embodiments will be described in detail, with reference to the following figures, wherein like designations denote like members, wherein:

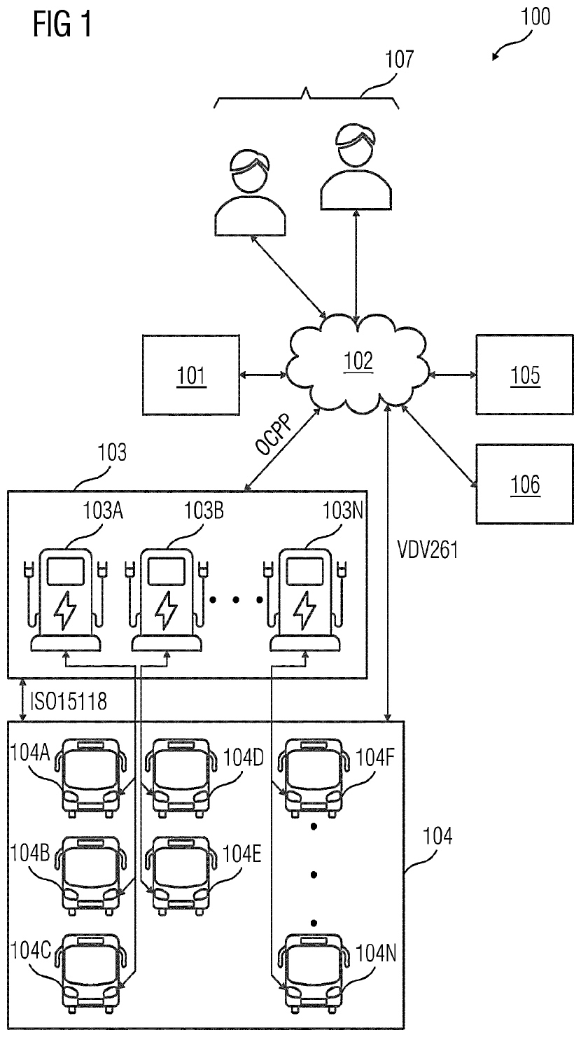

FIG. 1 illustrates a system comprising a cabin preconditioning system in communication with a charging station comprising one or more chargers each of which is connectable to multiple vehicles, according to an embodiment of the present disclosure;

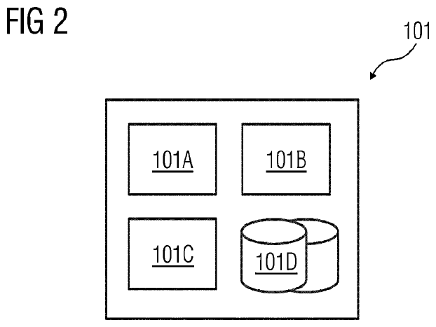

FIG. 2 illustrates the cabin preconditioning system shown in FIG. 1, for preconditioning a cabin of vehicle(s), according to an embodiment of the present disclosure;

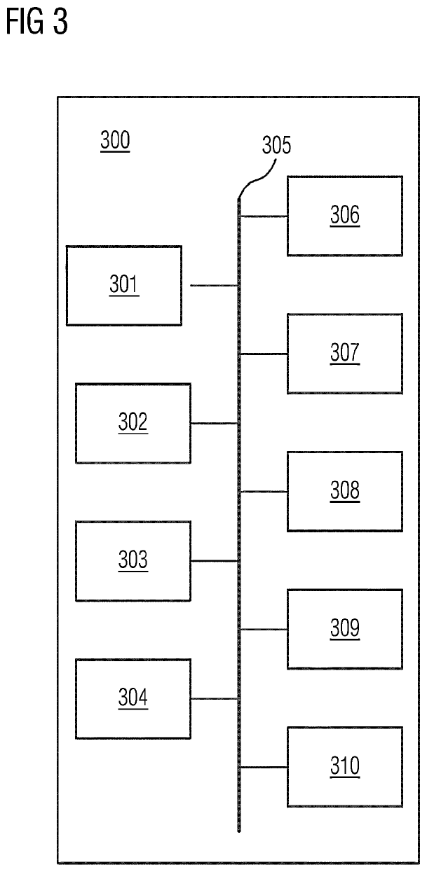

FIG. 3 is a block diagram illustrating an architecture of a computer system employed by the cabin preconditioning system shown in FIGS. 1-2, for preconditioning a cabin of vehicle(s), according to an embodiment of the present disclosure;

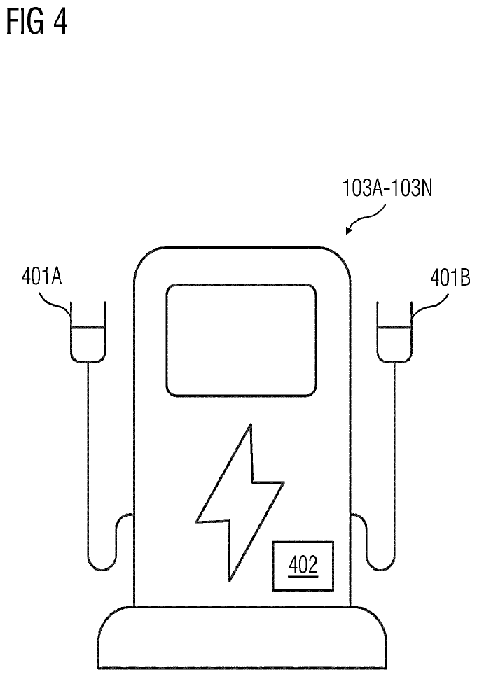

FIG. 4 illustrates a charger for preconditioning a cabin of vehicle(s), according to an embodiment of the present disclosure;

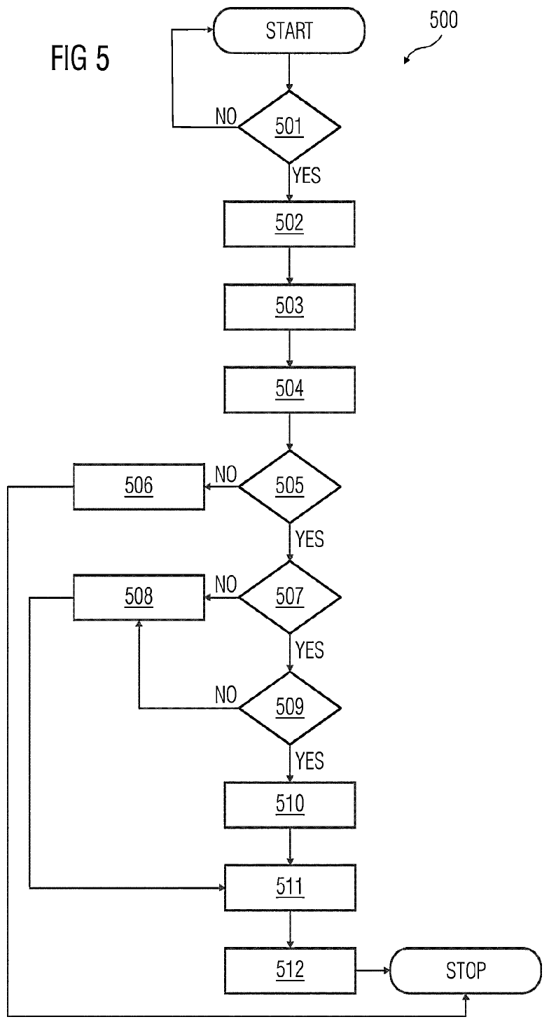

FIG. 5 illustrates a process flowchart of a computer-implemented method for preconditioning a cabin of vehicle(s), according to an embodiment of the present disclosure; and

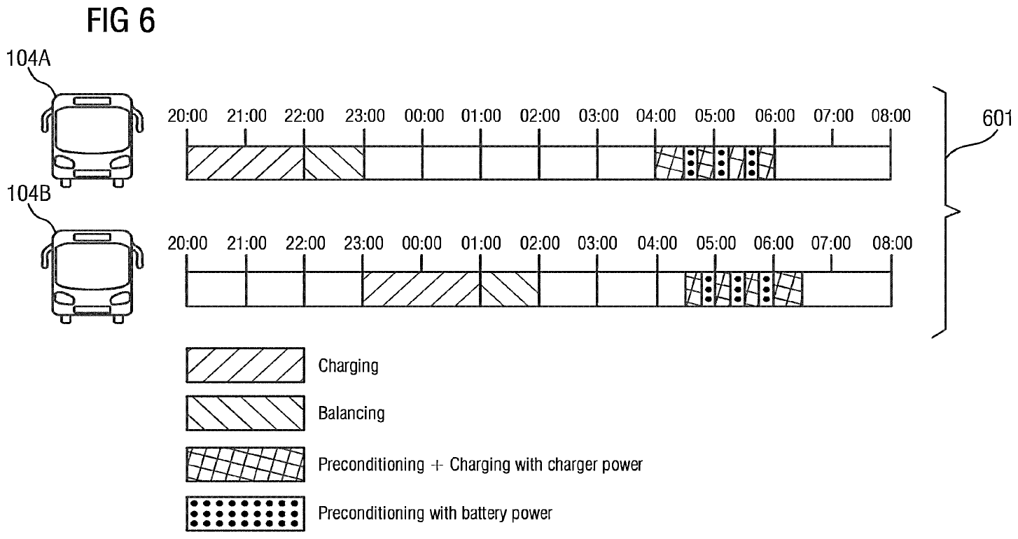

FIG. 6 illustrates an exemplary cabin preconditioning profile generated by the computer implemented method shown in FIG. 5, according to an embodiment of the present disclosure.

### DETAILED DESCRIPTION

Various embodiments are described with reference to the drawings, wherein like reference numerals are used to refer like elements throughout. In the following description, for the purpose of explanation, numerous specific details are set forth in order to provide thorough understanding of one or more embodiments. It may be evident that such embodiments may be practiced without these specific details.

FIG. 1 illustrates a system 100 comprising a cabin preconditioning system 101 in communication with a charging station 103 comprising one or more chargers 103A-103N each of which is connectable, for example, in a wired or wireless manner, to multiple vehicles 104A-104N, according to an embodiment of the present disclosure. The chargers 103A-103N are sequential chargers. The vehicles 104A-104N have at least a partial electric drive and therefore require to be charged via electric chargers 103A-103N.

The cabin preconditioning system 101 disclosed herein is installable on and accessible by a user device, for example, a personal computing device, a workstation, a client device, a network enabled computing device, any other suitable computing equipment, and combinations of multiple pieces of computing equipment being used by a user 107.

The cabin preconditioning system 101 disclosed herein is in an operable communication with a communication network 102. The communication network 102 is, for example, a wired network, a wireless network, or a network formed from any combination thereof. The cabin preconditioning system 101 is configurable as a web-based platform, for example, a website hosted on a server or a network of servers, or, is implemented in the cloud computing environment as a cloud computing-based platform implemented as a service for preconditioning a cabin of the vehicles 104A-104N that are connectable to the charger 103A-103N. A user 107 of the cabin preconditioning system 101 in this case accesses the cabin preconditioning system 101 via the communication network 102. The cabin preconditioning system 101 may have one or more users 107 for example, a charge point operator managing the charging station 103, a fleet manager managing a fleet 104 of the vehicles 104A-104N, etc.

The chargers 103A-103N of the charging station 103 can establish a communication with the cabin preconditioning system 101 via the communication network 102, for example, using the open charge point protocol (OCPP). The vehicle(s) 104A-104N once connected to the charger(s) 103A-103N can avail the value-added service according to VDV 261 offered under ISO 15118 and in turn directly communicate with the cabin preconditioning system 101 via the communication network 102.

The cabin preconditioning system 101 is also in communication with a fleet management system 105 and an energy management system 106, via the communication network 102. The fleet management system 105 includes data associated with the fleet 104 of the vehicles 104A-104N. The energy management system 106 includes data associated with an external power supply that is used by the charging station 103 for charging the vehicles 104A-104N.

FIG. 2 illustrates the cabin preconditioning system 101 shown in FIG. 1, for preconditioning a cabin of vehicle(s) 104A-104N connectable to a charger 103A-103N, according to an embodiment of the present disclosure.

The cabin preconditioning system 101 disclosed herein comprises a non-transitory computer readable storage medium and at least one processor communicatively coupled to the non-transitory computer readable storage medium. As used herein, “non-transitory computer readable storage medium” refers to all computer readable media, for example, non-volatile media, volatile media, and transmission media except for a transitory, propagating signal. The non-transitory computer readable storage medium is configured to store computer program instructions defined by modules, for example, 101A, 101B, etc., of the cabin preconditioning system 101.

The processor is configured to execute the defined computer program instructions. As illustrated in FIG. 2, the cabin preconditioning system 101 comprises a graphical user interface (GUI) 101C. A user 107 using the user device can access the cabin preconditioning system 101 via the GUI 101C. The GUI 101C is, for example, an online web interface, a web based downloadable application interface, etc. The cabin preconditioning system 101 further comprises a data reception module 101A and a data processing module 101B. The cabin preconditioning system 101 also includes a preconditioning database 101D.

The data reception module 101A obtains vehicle data, departure schedule, data associated with the chargers 103A-103N, and/or data associated with an external power supply used by the chargers 103A-103N for preconditioning the cabins of the vehicles 104A-104N, in communication with the charger(s) 103A-103N, the vehicle(s) 104A-104N and/or the fleet management system 105, and the energy management system 106 respectively.

The vehicle data comprises preconditioning requirements of the vehicles 104A-104N and battery data associated with an energy storage device of the vehicles 104A-104N. The preconditioning requirements comprise preconditioning energy and preconditioning duration. The battery data comprises a state of charge of the energy storage device at the time of connection of the vehicles 104A-104N to the charger 103A-103N and a rate of charging of the energy storage device when connected to the charger 103A-103N.

The data processing module 101B detects a connection of the vehicle(s) 104A-104N to the charger 103A-103N, generates a cabin preconditioning profile for the charger 103A-103N based on the vehicle data, the departure schedule, and a number of vehicles 104A-104N connected to the charger 103A-103N, and transfers the cabin preconditioning profile to the charger 103-103N for preconditioning the cabin of the vehicle(s) 104A-104N connected to the charger 103A-103N.

The data processing module 101B determines a number of vehicles 104A-104N connected to the charger 103A-103N, determines, based on the departure schedule and the preconditioning requirements, a preconditioning start time for the vehicle(s) 104A-104N connected to the charger 103A-103N, determines, based on the preconditioning start time and the preconditioning requirements, a preconditioning overlap between two or more vehicles 104A-104N when the number of vehicles 104A-104N connected to the charger 103A-103N is greater than one, and determines a charger power output of the charger 103A-103N using the preconditioning requirements and/or the battery data, based on the number of vehicles 104A-104N and the preconditioning overlap.

The data processing module 101B generates the charger power output based on the preconditioning requirements when the number of vehicles 104A-104N connected to the charger 103A-103N is equal to one or when the number of vehicles 104A-104N connected to the charger 103A-103N is greater than one with absence of the preconditioning overlap.

The data processing module 101B generates the charger power output based on the preconditioning requirements and the battery data when the number of vehicles 104A-104N connected to the charger 103A-103N is greater than one with presence of the preconditioning overlap.

The data processing module 101B stores the cabin preconditioning profiles in the preconditioning database 101D.

FIG. 3 is a block diagram illustrating an architecture of a computer system 300 employed by the cabin preconditioning system 101 shown in FIGS. 1-2, for preconditioning a cabin of vehicle(s) 104A-104N connectable to the charger(s) 103A-103N, according to an embodiment of the present disclosure.

The cabin preconditioning system 101 employs the architecture of the computer system 300. The computer system 300 is programmable using a high-level computer programming language. The computer system 300 may be implemented using programmed and purposeful hardware. The computer system 300 comprises a processor 301, a non-transitory computer readable storage medium such as a memory unit 302 for storing programs and data, an input/output (I/O) controller 303, a network interface 304, a data bus 305, a display unit 306, input devices 307, a fixed media drive 308 such as a hard drive, a removable media drive 309 for receiving removable media, output devices 310, etc.

The processor 301 refers to any one of microprocessors, central processing unit (CPU) devices, finite state machines, microcontrollers, digital signal processors, an application specific integrated circuit (ASIC), a field-programmable gate array (FPGA), etc., or any combination thereof, capable of executing computer programs or a series of commands, instructions, or state transitions. The processor 301 may also be implemented as a processor set comprising, for example, a general-purpose microprocessor and a math or graphics co-processor. The cabin preconditioning system 101 disclosed herein is not limited to a computer system 300 employing a processor 301. The computer system 300 may also employ a controller or a microcontroller. The processor 301 executes the modules, for example, 101A, 101B, etc., of the cabin preconditioning system 101.

The memory unit 302 is used for storing programs, applications, and data. For example, the modules 101A, 101B, etc., of the cabin preconditioning system 101 are stored in the memory unit 302 of the computer system 300. The memory unit 302 is, for example, a random-access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The I/O controller 303 controls input actions and output actions performed by the cabin preconditioning system 101.

The network interface 304 enables connection of the computer system 300 to the communication network 102. For example, the cabin preconditioning system 101 connects to the communication network 102 via the network interface 304. In an embodiment, the network interface 304 is provided as an interface card also referred to as a line card. The network interface 304 comprises, for example, interfaces using serial protocols, interfaces using parallel protocols, and Ethernet communication interfaces, interfaces based on wireless communications technology such as satellite technology, radio frequency (RF) technology, near field communication, etc. The data bus 305 permits communications between the modules, for example, 101A, 101B, etc., of cabin preconditioning system 101.

The display unit 306, via the graphical user interface (GUI) 205, displays information such as the charging profiles, etc. The display unit 306, via the GUI 101C, also displays information such as user interface elements including text fields, buttons, windows, etc., for allowing a user to provide his/her inputs such as thresholds for determining low voltage conditions, offline nodes, etc. The display unit 306 comprises, for example, a liquid crystal display, a plasma display, an organic light emitting diode (OLED) based display, etc. The input devices 307 are used for inputting data into the computer system 300. The input devices 307 are, for example, a keyboard such as an alphanumeric keyboard, a touch sensitive display device, and/or any device capable of sensing a tactile input.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the communication network 102. Computer applications and programs are executed by double clicking a related icon displayed on the display unit 306 using one of the input devices 307. The output devices 310 output the results of operations performed by the cabin preconditioning system 101. For example, the cabin preconditioning system 101 provides graphical representation of the cabin preconditioning profiles generated, using the output devices 310.

The processor 301 executes an operating system. The computer system 300 employs the operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the users using one of the input devices 307, the output display, files, and directories stored locally on the fixed media drive 308. The operating system on the computer system 300 executes different programs using the processor 301. The processor 301 and the operating system together define a computer platform for which application programs in high level programming languages are written.

The processor 301 of the computer system 300 employed by the cabin preconditioning system 101 retrieves instructions defined by the modules IOTA, 101B, etc., of the cabin preconditioning system 101 for performing respective functions disclosed in the detailed description of FIG. 2. The processor 301 retrieves instructions for executing the modules, for example, IOTA, 101B, etc., of the cabin preconditioning system 101 from the memory unit 302. A program counter determines the location of the instructions in the memory unit 302. The program counter stores a number that identifies the current position in the program of each of the modules, for example, 101A, 101B, etc., of the cabin preconditioning system 101. The instructions fetched by the processor 301 from the memory unit 302 after being processed are decoded. The instructions are stored in an instruction register in the processor 301. After processing and decoding, the processor 301 executes the instructions, thereby performing one or more processes defined by those instructions.

At the time of execution, the instructions stored in the instruction register are examined to determine the operations to be performed. The processor 301 then performs the specified operations. The operations comprise arithmetic operations and logic operations. The operating system performs multiple routines for performing several tasks required to assign the input devices 307, the output devices 310, and memory for execution of the modules, for example, 101A, 101B, etc., of the cabin preconditioning system 101. The tasks performed by the operating system comprise, for example, assigning memory to the modules, for example, 101A, 101B, etc., of the cabin preconditioning system 101, and to data used by the cabin preconditioning system 101, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 101A, 101B, etc., of the cabin preconditioning system 101 are displayed to the user on the GUI 101C.

For purposes of illustration, the detailed description refers to the cabin preconditioning system 101 being run locally on the computer system 300, however the scope of embodiments of the present invention is not limited to the cabin preconditioning system 101 being run locally on the computer system 300 via the operating system and the processor 301, but may be extended to run remotely over the communication network 102 by employing a web browser and a remote server, a mobile phone, or other electronic devices. One or more portions of the computer system 300 may be distributed across one or more computer systems (not shown) coupled to the communication network 102.

Disclosed herein is also a computer program product comprising a non-transitory computer readable storage medium that stores computer program codes comprising instructions executable by at least one processor 301 for preconditioning a cabin of vehicle(s) 104A-104N connectable to the charger 103A-103N, as disclosed in aforementioned description.

The computer program product comprises a first computer program code for detecting a connection of the one or more vehicles 104A-104N to the charger 103A-103N; a second computer program code for obtaining vehicle data and departure schedule associated with each of the vehicle(s) 104A-104N connected to the charger 103A-103N; a third computer program code for generating a cabin preconditioning profile for the charger 103A-103N based on the vehicle data, the departure schedule, and a number of vehicles 104A-104N connected to the charger 103A-103N; and a fourth computer program code for transferring the cabin preconditioning profile to the charger 103A-103N for preconditioning the cabin of the vehicle(s) 103A-103N connected to the charger 103A-103N.

The third computer program code comprises a fifth computer program code for determining a number of vehicles 104A-104N connected to the charger 103A-103N; a sixth computer program code for determining, based on the departure schedule and the preconditioning requirements, a preconditioning start time for the vehicle(s) 104A-104N connected to the charger 103A-103N; a seventh computer program code for determining, based on the preconditioning start time and the preconditioning requirements, a preconditioning overlap between two or more vehicles 104A-104N when the number of vehicles 104A-104N connected to the charger 103A-103N is greater than one; and an eight computer program code for determining a charger power output of the charger 103A-103N using the preconditioning requirements and/or the battery data, based on the number of vehicles 104A-104N and the preconditioning overlap.

In an embodiment, a single piece of computer program code comprising computer executable instructions, performs one or more steps of the computer implemented method according to the present disclosure, for preconditioning a cabin of vehicle(s) 104A-104N connectable to the charger 103A-103N. The computer program codes comprising computer executable instructions are embodied on the non-transitory computer readable storage medium. The processor 301 of the computer system 300 retrieves these computer executable instructions and executes them. When the computer executable instructions are executed by the processor 301, the computer executable instructions cause the processor 301 to perform the steps of the computer implemented method for preconditioning a cabin of vehicle(s) 104A-104N connectable to the charger 103A-103N.

FIG. 4 illustrates a charger 103A-103N for preconditioning a cabin of vehicle(s) 104A-104N as shown in FIG. 1, according to an embodiment of the present disclosure. The charger 103A-103N comprises connector(s) 401A, 401B via which the vehicles 104A-104N connect to the charger 103A-103N. The charger comprises a control unit 402 that detects a connection of the vehicle(s) 104A-104N to the connectors 401A or 401B, obtains vehicle data and departure schedule associated with each of the vehicle(s) 104A-104N, and generates a cabin preconditioning profile for the charger 103A-103N based on the vehicle data, the departure schedule, and a number of the vehicle(s) 104A-104N connected to the charger 103A-103N for preconditioning the cabin of the vehicle(s) 104A-104N.

The control unit 402 of the charger 103A-103N in order to generate the cabin preconditioning profile, determines a number of the vehicles 104A-104N connected to the charger 103A-103N, for example, via the connectors 401A-401B, determines, based on the departure schedule and the preconditioning requirements, a preconditioning start time for the vehicles 104A-104N connected to the charger 103A-103N, determines, based on the preconditioning start time and the preconditioning requirements, a preconditioning overlap between two or more of the vehicles 104A-104N when the number of the vehicles 104A-104N connected to the charger 103A-103N is greater than one, determines a charger power output of the charger 103A-103N in accordance with the preconditioning requirements, the battery data, the number of the vehicles 104A0-104N, and the preconditioning overlap, and generates the cabin preconditioning profile using the preconditioning start time and the charger power output for each of the vehicle(s) 104A-104N connected to the charger 103A-103N.

The control unit 402 of the charger 103A-103N determines the charger power output based on the preconditioning requirements when the number of the vehicles 104A-104N connected to the charger 103A-103N is equal to one.

The control unit 402 of the charger 103A-103N determines the charger power output based on the preconditioning requirements when the number of the vehicles 104A-104N connected to the charger 103A-103N is greater than one with absence of the preconditioning overlap.

The control unit 402 of the charger 103A-103N determines the charger power output based on the preconditioning requirements and the battery data when the number of the vehicles 104A-104N connected to the charger 103A-103N is greater than one with presence of the preconditioning overlap.

The charger 103A-103N is a sequential charger that provides the charger power output to no more than one of the vehicles(s) 104A-104N at any given time.

FIG. 5 illustrates a process flowchart 500 of a computer-implemented method for preconditioning a cabin of vehicle(s) 104A-104N connectable to a charger 103A-103N, according to an embodiment of the present disclosure.

Upon start of the process the computer implemented method, at step 501, detects whether at least one vehicle 104A-104N is connected to a charger 103A-103N. The process flowchart 500 disclosed herein is implemented per charger 103A-103N. If there is a connection detected between the vehicle(s) 104A-104N and the charger 103A-103N, then at step 502, the computer implemented method obtains vehicle data from the vehicle(s) 104A-104N connected to the charger 103A-103N.

The vehicle data comprises, for example, a vehicle identification number, a vehicle communication controller identification number, a battery capacity, that is, a capacity of the energy storage device installed in the vehicle 104A-104N for storing charge therewithin, a maximum charging power that the battery can store and/or handle, a rate of charging of the battery, and battery balancing parameters such as balancing power, balancing duration, and a state of charge (SoC) of the battery.

The vehicle data also comprises preconditioning requirements of the vehicle 104A-104N. The preconditioning requirements include preconditioning energy and preconditioning duration. The preconditioning energy refers to the amount of energy required by the vehicle 104A-104N for preconditioning the cabin. The preconditioning duration refers to a time period for which the preconditioning is performed. For example, a vehicle 104A-104N such as an e-Bus may require 10 kWh of preconditioning energy for 2 hours of preconditioning.

The vehicle data is obtained, for example, from a charger management system (not shown) associated with the charging station 103 that stores therein vehicle data of each vehicle which is onboarded onto the charger management system. Alternatively, the vehicle data is obtained directly from the vehicle 104A-104N via the communication network 102. Alternatively, the vehicle data may be obtained ahead of time via a vehicle telematic system that communicates, for example, SoC of the battery of the vehicle 104A-104N while the vehicle 104A-104N is en route to the charging station 103. The computer implemented method may store the vehicle data in the preconditioning database 101D of the cabin preconditioning system 101.

The computer implemented method, at step 503, obtains a departure schedule associated with the vehicles 104A-104N connected to the charger 103A-103N. The departure schedule comprises a time schedule of the vehicles 104A-104N having an expected departure time of the vehicle 104A-104N from the charging station 103. The departure schedule is obtained from the fleet management system 105 shown in FIG. 1, via the communication interface 102.

The computer implemented method, at step 504, obtains power data from the energy management system 106 via the communication interface 102. The power data comprises availability of the power from an external power supply being used by the charging station 103. The power data may also comprise a cost associated with the power at different times in a day. The computer implemented method, at step 505, determines whether the preconditioning energy required by the vehicle 104A-104N, from the vehicle data, is lesser than the corresponding power available at a given time instant. If not, then at step 506, the computer implemented method generates a notification to the user 107 for low power availability and renders the notification to the user 107 via the GUI 101C of the cabin preconditioning system 101 being employed by the computer implemented method disclosed herein. If yes, then at step 507, the computer implemented method determines whether more than one vehicle 104A-104N is connected to the charger 103A-103N.

If not, that is, if only one vehicle 104A-104N is connected to the charger 103A-103N, then at step 508, the computer implemented method determines a preconditioning start time and a charger power output of the charger 103A-103N to which the vehicle 104A-104N is connected.

The preconditioning start time is determined based on the preconditioning duration and the expected departure time, represented as below:

$$PST = \vert PD - DT \vert$$

Where PST represents the preconditioning start time, PD represents the preconditioning duration and DT represents the expected departure time of the vehicle 104A-104N.

Similarly, the charger power output is determined based on the preconditioning duration and the preconditioning energy, and is represented as below:

$${P}_{output} = PE / PD$$

Where Pₒᵤₜₚᵤₜ is the charger power output, PE is the preconditioning energy requirement of the vehicle 104A-104N and PD is the preconditioning duration requirement of the vehicle 104A-104N.

If yes, that is, if more than one vehicle 104A-104N is connected to the charger 103A-103N, then at step 509, the computer implemented method determines whether there exists a preconditioning overlap based on the preconditioning requirements from the vehicle data. For example, if two vehicles 104A and 104B are connected to the charger 103A via two connectors 401A-401B of the charger 103A, and the expected departure times of these vehicles 104A and 104B are 6:00 AM and 6:30 AM respectively and the preconditioning duration is 2 hours for each of them, then there exists a preconditioning overlap because the preconditioning start time of these vehicles 104A and 104B would be 4:00 AM and 4:30 AM respectively and the preconditioning duration would be of 2 hours. Thus, the time period of 4:30 AM to 6:00 AM would be a preconditioning overlap. Whereas, if the expected departure time of the vehicle 104B was 8:00 AM then there would not exist any preconditioning overlap as the preconditioning start time for this vehicle 104B would then be 6:00 AM.

If there exists no preconditioning overlap, then the computer implemented method repeats step 508, that is, determines the preconditioning start time(s) and the charger power output(s) for each of the vehicles 104A-104B connected to the charger 103A-103N.

If there exists a preconditioning overlap, then the computer implemented method at step 510, determines a charger power output of the charger 103A-103N to which the vehicles 104A-104N are connected for charging. For the time period corresponding to the preconditioning overlap, the computer implemented method generates the charger power output which is provided to the vehicles 104A-104N on a time-shared basis, for example, in a round robin fashion wherein the charger 103A-103N and the batteries of the vehicles 104A-104N alternate in providing energy to the respective vehicles 104A-104N for cabin preconditioning. The charger power output is determined based on the preconditioning requirements from the vehicle data, the rate of charging of the battery from the vehicle data, and an estimated loss of SoC of the battery that would occur due to the time-shared charging. The estimated loss of SoC of the battery may be verified and calibrated with the actual loss of SoC of the battery during the time-shared charging. The charger power output may be represented as below:

$${P}_{output} = [ \frac{PE}{PD} ] + [ {SoC}_{Loss} * RoC ]$$

Where Pₒᵤₜₚᵤₜ is the charger power output, PE is the preconditioning energy requirement of the vehicle 104A-104N, PD is the preconditioning duration requirement of the vehicle 104A-104N, SoC_{Loss} is the loss of the SoC of the battery and RoC is the rate of charging of the battery.

At step 511, the computer implemented method generates a cabin preconditioning profile for the charger 103A-103N to which the vehicle(s) 104A-104N is/are connected, based on the charger power output Pₒᵤₜₚᵤₜ and/or the preconditioning start time PST. For example, the cabin preconditioning profile for a charger 103A-103N that has two connectors 401A and 401B and two vehicles 104A-104B connected thereto which have a preconditioning overlap, may be represented as below in Table 1:

TABLE 1

| | Vehicle 104A having | Vehicle 104B having |
|---|---|---|
| | expected departure | expected departure |
| Preconditioning | time as 6:00 AM | time as 6:30 AM |
| Start Time | Connector 401A | Connector 401B |
| (PST) | Power Output (Pₒᵤₜₚᵤₜ) | Power Output (Pₒᵤₜₚᵤₜ) |
| 4:00AM-4:30 AM | Pₒᵤₜₚᵤₜ = 10 kW | — |
| 4:30 AM-4:45 AM | Pₒᵤₜₚᵤₜ = 0 kW | Pₒᵤₜₚᵤₜ = 10 kW |
| 4:45 AM-5:00 AM | Pₒᵤₜₚᵤₜ = 10 kW | Pₒᵤₜₚᵤₜ = 0 kW |
| 5:00 AM-5:15 AM | Pₒᵤₜₚᵤₜ = 0 kW | Pₒᵤₜₚᵤₜ = 10 kW |
| 5:15 AM-5:30 AM | Pₒᵤₜₚᵤₜ = 10 kW | Pₒᵤₜₚᵤₜ = 0 kW |
| 5:30 AM-5:45 AM | Pₒᵤₜₚᵤₜ = 0 kW | Pₒᵤₜₚᵤₜ = 10 kW |
| 5:45 AM-6:00 AM | Pₒᵤₜₚᵤₜ = 10 kW | Pₒᵤₜₚᵤₜ = 0 kW |
| 6:00 AM-6:30 AM | — | Pₒᵤₜₚᵤₜ = 10 kW |

In the aforementioned example, it is assumed that both the vehicles 104A and 104B have same preconditioning requirements. However, the computer implemented method determines the charger power output per connector 401A-401B of the charger 103A-103N and per vehicle 104A-104N connected thereto based on the preconditioning requirements. Thus, the charger 103A-103N is capable of delivering different powers to different vehicles 104A-104N via the connectors 401A-401B. The power delivery is limited by maximum power delivery capacity of the charger 103A-103N and/or maximum power limit of the connectors 401A-401B.

The computer implemented method, as seen from the above table, at step 511, divides the preconditioning overlap into two or more time-intervals, for example, of a predefined duration such as 15 mins, to alternate delivery of power to the two vehicles 104A and 104B via the two connectors 401A and 401B. These time intervals may be determined based on the preconditioning requirements of the vehicles 104A-104B, the charger power output of the charger 103A-103N, etc. The time intervals may also be configured by a user 107 of the cabin preconditioning system 101 which is employed by the computer implemented method disclosed herein.

The time intervals in which the charger 103A-103N is delivery 0 kW of power to the vehicle 104A or 104B, the battery of the vehicle 104A or 104B delivers power thus alternating with the charger 103A-103N. The computer implemented method may determine the actual loss of SoC during one of these time intervals for example, between 4:30 AM to 4:45 AM as seen above, to verify the estimated loss of SoC used for determining the charger power output. If the difference between the actual loss of SoC and the estimated loss of SoC is greater than a predefined tolerance threshold, then the computer implemented method updates the charger power output calculation with the actual loss of SoC and uses this modified charger power output in the next time interval, that is, 4:45 AM to 5:00 AM. Alternatively, the estimated loss of SoC may be provided and/or validated by a user 107 of the cabin preconditioning system 101 which is employed by the computer implemented method disclosed herein.

At step 512, the computer implemented method transfers the cabin preconditioning profile to the charger 103A-103N for preconditioning the cabin of the vehicle(s) 104A-104N connected thereto.

FIG. 6 illustrates an exemplary cabin preconditioning profile 601 generated by the computer implemented method shown in FIG. 5, according to an embodiment of the present disclosure. The cabin preconditioning profile 601 corresponds to the data shown in Table 1 of detailed description of FIG. 5. As shown, there exists a preconditioning overlap between the two vehicles 104A and 104B connected to a charger 103A shown in FIG. 1 and FIG. 4. The preconditioning overlap exists between 4:30 AM to 6:00 AM. This period corresponding to the preconditioning overlap is divided into multiple time intervals of 15 minutes each, in which the charger power output from the charger 103A-103N is delivered alternately to the vehicles 104A and 104B. For example, from 4:30 AM to 4:45 AM the vehicle 104B receives the charger power output and the vehicle 104A receives equivalent power from its battery. This is reversed for the next time interval, that is, 4:45 AM to 5:00 AM and so on.

Where databases are described such as the preconditioning database 101D, it will be understood by one of ordinary skill in the conventional art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the conventional art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present disclosure can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN)

1. A computer implemented method for preconditioning a cabin of one or more vehicles, the computer implemented method comprising:
detecting a connection of the one or more vehicles to a charger;
obtaining vehicle data and departure schedule associated with each of the one or more vehicles connected to the charger, wherein the vehicle data comprises preconditioning requirements of the one or more vehicles and battery data associated with an energy storage device of the one or more vehicles;
generating a cabin preconditioning profile for the charger based on the vehicle data, the departure schedule, and a number of the one or more vehicles connected to the charger; and
transferring the cabin preconditioning profile to the charger for preconditioning the cabin of the one or more vehicles connected to the charger.

2. The computer implemented method according to claim 1, wherein the preconditioning requirements comprise preconditioning energy and preconditioning duration required for preconditioning the cabin of the one or more vehicles.

3. The computer implemented method according to claim 1, wherein the battery data comprises a state of charge of the energy storage device at a time of connection of the vehicles to the charger and a rate of charging of the energy storage device when connected to the charger.

4. The computer implemented method according to claim 1, wherein generating the cabin preconditioning profile comprises:
determining a number of the vehicles connected to the charger;
determining, based on the departure schedule and the preconditioning requirements, a preconditioning start time for the vehicles connected to the charger;
determining, based on the preconditioning start time and the preconditioning requirements, a preconditioning overlap between two or more of the vehicles when the number of the vehicles connected to the charger is greater than one;
determining a charger power output of the charger in accordance with the preconditioning requirements, the battery data, the number of the vehicles, and the preconditioning overlap; and
generating the cabin preconditioning profile using the preconditioning start time and the charger power output for each of the one or more vehicles connected to the charger.

5. The computer implemented method according to claim 4, wherein the charger power output is determined based on:
the preconditioning requirements when the number of the vehicles connected to the charger is equal to one,
the preconditioning requirements when the number of the vehicles connected to the charger is greater than one with absence of the preconditioning overlap; or
the preconditioning requirements and the battery data when the number of the vehicles connected to the charger is greater than one with presence of the preconditioning overlap.

6. The computer implemented method according to claim 4, wherein the cabin preconditioning profile comprises a plurality of time intervals corresponding to the preconditioning overlap, and wherein the charger power output from the charger is alternately allocated to two or more of the vehicles in each of the time intervals.

7. The computer implemented method according to claim 6, wherein the cabin preconditioning profile comprises providing the charger power output from the charger to no more than one of the two or more vehicles at any given time.

8. A computer program product, comprising a computer readable hardware storage device having computer readable program code stored therein, and program code executable by a processor of a computer system to implement a method according to claim 1.

9. A cabin preconditioning system for preconditioning a cabin of one or more vehicles, the cabin preconditioning system comprising:
a non-transitory computer readable storage medium storing computer program instructions defined by modules of the cabin preconditioning system;
at least one processor communicatively coupled to the non-transitory computer readable storage medium, wherein the at least one processor configured to execute the computer program instructions; and
the modules of the cabin preconditioning system configured to perform the computer implemented method according to claim 1.

10. A charger for preconditioning a cabin of one or more vehicles, the charger comprising:
one or more connectors via which the one or more vehicles connect to the charger;
a control unit configured to:
detect a connection of the one or more vehicles to the one or more connectors;
obtain vehicle data and departure schedule associated with each of the one or more vehicles, wherein the vehicle data comprises preconditioning requirements of the one or more vehicles and battery data associated with an energy storage device of the one or more vehicles, and wherein the preconditioning requirements comprise preconditioning energy and preconditioning duration required for preconditioning the cabin of the one or more vehicles, and wherein the battery data comprises a state of charge of the energy storage device at the time of connection of the one or more vehicles to the charger and a rate of charging of the energy storage device when connected to the charger; and
generate a cabin preconditioning profile for the charger based on the vehicle data, the departure schedule, and a number of the one or more vehicles connected to the charger for preconditioning the cabin of the one or more vehicles.

11. The charger according to claim 10, wherein in generating the cabin preconditioning profile, the control unit is configured to:
determine a number of the vehicles connected to the charger;
determine, based on the departure schedule and the preconditioning requirements, a preconditioning start time for the vehicles connected to the charger;
determine, based on the preconditioning start time and the preconditioning requirements, a preconditioning overlap between two or more of the vehicles when the number of the vehicles connected to the charger is greater than one;
determine a charger power output of the charger in accordance with the preconditioning requirements, the battery data, the number of the vehicles, and the preconditioning overlap; and
generate the cabin preconditioning profile using the preconditioning start time and the charger power output for each of the one or more vehicles connected to the charger.

12. The charger according to claim 11, wherein the control unit is configured to determine the charger power output based on:
the preconditioning requirements when the number of the vehicles connected to the charger tis equal to one,
the preconditioning requirements when the number of the vehicles connected to the charger is greater than one with absence of the preconditioning overlap, or
the preconditioning requirements and the battery data when the number of the vehicles connected to the charger is greater than one with presence of the preconditioning overlap.

13. The charger according to claim 10, wherein the cabin preconditioning profile comprises a plurality of time intervals corresponding to the preconditioning overlap, and wherein the charger power output from the charger is alternately allocated to two or more of the vehicles in each of the time intervals.

14. The charger according to claim 10, is a sequential charger configured to provide the charger power output to no more than one of the two or more vehicles at any given time.
